(19) United States
(12) Patent Application Publication
(10) Pub. No.: US 2002/0028077 A1
(43) Pub. Date: Mar. 7, 2002

(54) Single lens reflex camera body cap with lens

(76) Inventor: Anthony Lo, Hong Kong (CN)

Correspondence Address: ANTHONY LO, 901, 'D' STREET, PETALUMA, CA, 94952-4030, US

(21) Appl. No.: 09/946,401

(22) Filed: Aug. 30, 2001

(30) Foreign Application Priority Data
Sep. 4, 2000 (GB) 0021586.3

(51) Int. Cl. G03B 9/02

(52) U.S. Cl. 396/505

(57) ABSTRACT

A camera body cap with a hole in line with which is fitted with a lens designed with the iris on the subject side of the lens. If provided with an adjustable iris, then a front cover shell may be included to act as a dust cover for the iris disc and a cut out window to show the f number detail of the iris selected.

### DESCRIPTION OF THE INVENTION

1. Field of the Invention

This invention relates to a camera body cap with a lens.

2. Background of the Invention

In the past, compact lenses were offered for 35 mm single lens reflex cameras, they were typically 40 mm focal 2.8 aperture and physically very short in length, they are known as a “Pan-cake” lens. While it is their compact size and light weight which make them attractive, they were delicate, conventional lenses with the iris set in between the lens elements and requires a lens cap for protection when not in use.

### SUMMARY OF THE INVENTION

Accordingly, the present invention is directed to a camera body cap with a lens that obviates one or more of the limitations and disadvantages of the prior art lenses. The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims.

To attain the advantages and in accordance with the purposes of the invention, as embodied and broadly described herein, the invention is directed to a “pan-cake” lens which is economical to produce, robust and ultra light weight. All the components can be moulded plastic, and it only requires one moving part. The iris also performs the role of a lens cap. At a glance, it looks like an ordinary body cap, hence the title: Body Cap with a Lens.

FIG. 1 shows a side sectional view of this invention mounted on a typical single lens reflex camera body.

By definition a single lens reflex camera has a mirror 1 between the film 2 and the lens 3 to deflect the lens image of the subject to be photographed 10 for viewing on the ground glass viewing screen 4 prior to exposure of the film 2. In order to clear the movement of the mirror 1, the locus 5 of the edge of the mirror 1 during the cycle of an exposure dictates the shortest back-focus 6 of any lens 3 that can be used on such a camera. To minimize this limitation, this invention teaches the use of a lens 3 single or multi-element where the iris 8 is in front of the lens 3, optically, for a given focal length, this design has a longer backfocus 6 than lenses with the iris 8 at the back or in between the lens elements. By having the iris 8 in the front, offers three (3) additional benefits:

1.) The iris 8 will not interfere with the movement of the mirror 1 (it would if it was designed at the rear of the lens common with point & shoot cameras).

2.) Where the iris is adjustable, the iris becomes directly and easily adjustable from the front of the camera, there are no linkages required.

3.) The adjustable iris can have a closed position which also acts as a lens cap.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate one embodiment of the invention and together with the description, serve to explain the principles of the invention.

FIG. 1 is a sectional view of the camera body cap with a lens fitted to a single lens reflex camera, showing the relative positions of the subject, the mirror, the ground glass viewing screen, the shutter and the film.

FIG. 2a shows the front view of a camera body cap with a lens provided with a waterwheel iris disc with four irises and a blank segment. It also shows the detend with a notch-engaging paw and a long slender arm spring loaded against a pin stop on the chassis. The front cover shell is omitted for clarity.

FIG. 2b shows a typical camera body cap with a lens, highlighting the back focus distance between the rear element of the lens and the film plane.

FIG. 3 is an exploded view of a typical camera body cap with a lens showing the relative positions of the key components.

### DESCRIPTION OF THE PREFERRED EMBODIMENTS

Reference will now be made in detail to the present embodiment and exemplary embodiments of the invention, an example of which is illustrated in the accompanying drawings. Wherever possible, the same reference numbers will be used throughout the drawings to refer to the same or like parts.

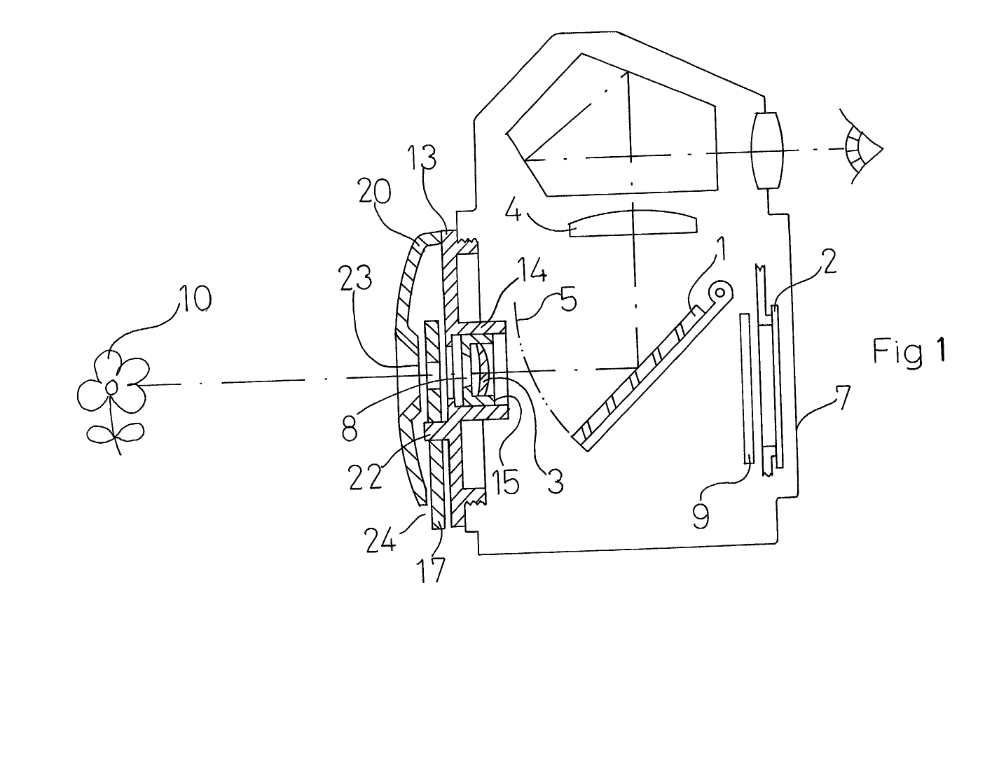

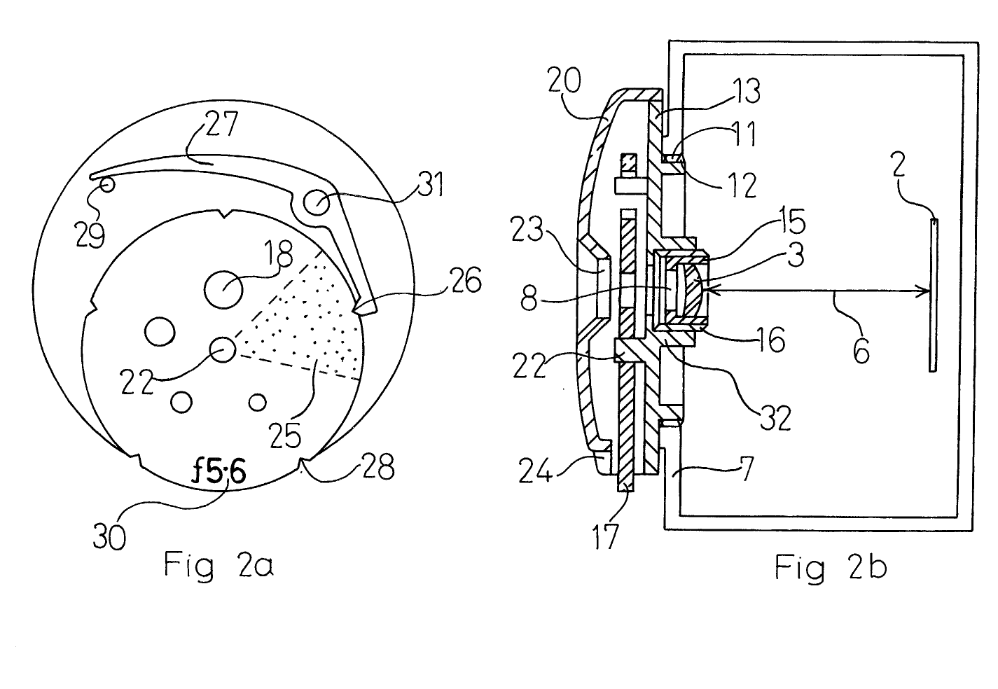

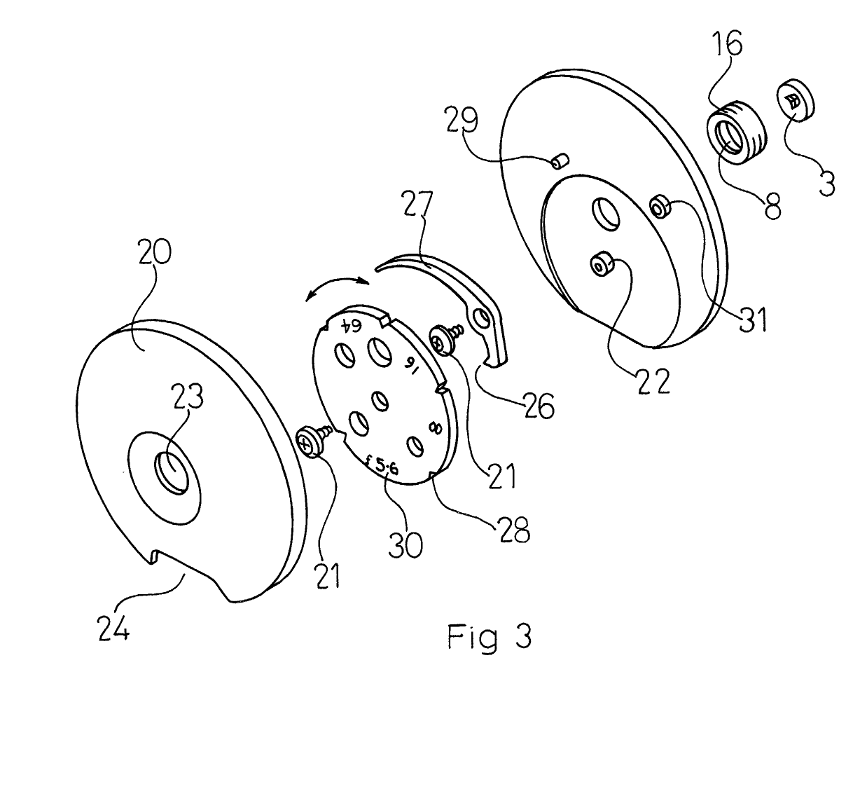

This invention is now explained by way of an example. FIG. 1 is a sectional view of a lens cap with a lens 3 which is attached to camera body 7 where the film 2 is covered by the shutter 9. Mirror 1 is the mirror which is reflecting the image from the camera lens 3 onto the ground glass viewing screen 4. Just before an exposure is made, the mirror 1 swings out of the light path between the lens 3 and the film 2. The edge of the mirror 1 describes the locus 5. It can be seen that any lens 3 assembly must not be closer to the film 2 than the locus 5 or the mirror 1 will not be able to retract and will obscure part of the image during exposure.

This invention teaches the use of a lens 3 (single element or multi elements) designed with an iris 8 mounted in front of the lens 3. The adjustable water wheel iris disc 17 is optional, will be describe in detail later. This type of lens 3 has the longest back-focus 6 compared with lenses with a mid-mounted or back-mounted iris 8. The benefit is for a given back-focus 6, the lens 3 with an iris 8 in the front has the widest angle of view recorded on a given size of film 2. The lens 3 also has the smallest area of exposure to any hostile ambient environment such as sand and salt sprays.

Modem lenses, particularly the auto focus auto diaphragm types can fail at the most awkward moments, such as when diaphragm blades get stuck, or when the auto focus mechanism fails, or when the whole lens assembly steams up upon rapid rise of ambient temperature such as leaving an air-conditioned room. When that happens, the whole camera is instantly rendered useless.

The camera body cap with a lens is the perfect spare or stand by lens for situations where light weight, compactness, immunity to hostile environment is needed. Thanks to its simple design, it costs a fraction of that of an ordinary camera lens assembly. Even if, in spite of its robust design, it is damaged beyond repair, its replacement cost is very modest.

The front cover shell 20 serves three purposes:

1.) It embellishes the design of the cap with a lens covering the front mounted adjustable iris.

2.) Its front cover shell cut-out 24 as shown on the exploded view neatly provides a view window for the selected size of iris stop 30 and other relevant information such as depth of field range.

3.) Where fitted, when the waterwheel iris disc 17 is adjusted to the “closed” position, the water wheel blank space provides a dust cover for the lens and the front cover shell 20 provides a dust cover for all the iris holes of the waterwheel iris disc 17 which is not in use.

In this example the camera body has a female screw thread mount 11 and the chassis of the invention 13 is attached to the camera body 7 by a male screw thread mount 12 which fits female screw thread mount 11.

It is common knowledge that it is also possible to design a standard chassis mount which when coupled to different adapter rings will enable a single standard chassis 13 to fit a series of different makes of camera bodies. Typical examples of these interchangeable mounts includes the T2 series by Soligor and the Adaptall 2 by Tamron.

Chassis 13 has a lens holder 14 concentric with its centre, into which, the image forming lens assembly comprising lens housing 15a and lens 15b is attached. If desired, the inside of the lens holder 14 may have a screw thread and the outside of the lens a corresponding lens housing screw thread 16 so that the lens may be screwed in and out to achieve the best focus on the film 2. In this simple fixed focus design, it is expected that with modem production methods, the focal length of the lens 3 can be controlled so that they can be fitted without adjustments.

A more sophisticated version of this invention teaches the use of an adjustable iris, in particular, a water wheel iris disc 17 which has a blank segment 25 so that when this segment is set in front of the lens 3, it acts as a cover to protect it. The circumference of the water wheel iris disc 17 is provided with V notches 28 at appropriate places so that spring loaded a detend 19 will keep the chosen iris 18 on the wheel correctly aligned with the optical axis of the lens. This is achieved by providing a shaft 31 on the subject side of the chassis acting as the pivot point of the detend 19 where the long slender arm 27 of the detend 19 serving as a leaf spring and the short engaging arm ending in a paw 26 to engage and disengage with V notches 28 on the waterwheel iris disc 17. The long slender arm 27 is always braced against a pin stop 29 set on the chassis 13 providing tension for the paw 26 to maintain its engagement with the circumference of the waterwheel iris disc 17. This “Lens Cap” is completed by fitting a front cover shell 20 over Chassis 13. A self-tapping screw 21 holds water wheel iris disc 17 to revolve on shaft 22. There are two openings on the front cover shell hole 23 and front cover shell hole cut-out 24. Front cover shell hole 23 is in the centre and allows the lens 3 to have an unrestricted view and front cover shell hole cut-out 24 is a cut-out on the circumference which not only allows easy manipulation of the water wheel iris disc 17 but also shows the chosen iris f-stop number and the depth of field range of the chosen f-stop number.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A camera body cap, comprising:
a chassis with an opening; and
an image-forming lens; and
a front mounted iris assembly where the iris assembly is aligned with the optical axis of the lens and the chassis opening to project an image of a subject on a film exposure.

2. The chassis of claim 1, wherein the lens is mounted in a housing which can be screwed into and out of a screw threaded opening in the chassis along the optical axis of the lens to focus the lens on the film exposure.

3. The chassis of claim 1, wherein an iris assembly can be aligned with the optical axis of the lens and mounted near the fixed iris of the lens on the subject side.

4. The chassis of claim 1, wherein a waterwheel disc with a series of different sized irises evenly spaced around a pitch circle is mounted near the fixed iris of the lens, so acting as an adjustable iris.

5. The chassis of claim 1, wherein a shaft is set into the chassis so that the waterwheel disc of claim 4 can be mounted on the chassis.

6. The waterwheel disc of claim 4, wherein the waterwheel disc is pivoted in such a manner as to rotate and allow each selected iris to align with the optical axis of the lens and regulate the amount of light passing through to the film.

7. The waterwheel disc of claim 4, wherein each iris on the waterwheel disc is labeled with its corresponding f-stop number allowing for selection of the appropriate iris under the cut-out provided by the front cover shell.

8. The waterwheel disc of claim 4, wherein the circumference of the waterwheel disc is provided with a series of notches to engage the paw on the end of a detend and lock each selected iris into position with the optical axis of the lens.

9. The waterwheel disc of claim 4, wherein one of the irises is blanked off so that when this iris is selected the lens is shielded.

10. The detend of claim 8, wherein the detend is pivoted on a closely fitted shaft projecting from the chassis.

11. The detend of claim 8, wherein the detend has a long slender arm serving as a leaf spring and a short engaging arm ending in a paw, serving to engage and disengage with notches on the waterwheel disc of claim 4 while the iris is being selected.

12. The detend of claim 8, wherein the end of the long slender arm is always braced against a pin stop set in the chassis, providing tension for the paw to maintain its engagement with the waterwheel disc.

13. The front cover shell of claim 7, wherein the front cover shell is attached to the chassis and provides an opening in the center which allows the lens to have an unrestricted view of the subject.

14. The front cover shell of claim 7 where a cut-out on the front cover shell allows manipulation of the iris waterwheel disk and display of the f-stop number of the selected iris.
